(19) United States
(12) Patent Application Publication
(10) Pub. No.: US 2026/0152646 A1
(43) Pub. Date: Jun. 4, 2026

(54) WATER-BASED RADIATIVE COOLING PAINT MIXTURES AND SINGLE-LAYER PAINTS FOR PASSIVE RADIATIVE COOLING

(71) Applicant: Purdue Research Foundation, West Lafayette, IN (US)

(72) Inventors: Xiulin Ruan, West Lafayette, IN (US); Abdulrahman Aljwirah, Lafayette, IN (US)

(21) Appl. No.: 19/122,969

(22) PCT Filed: Nov. 29, 2023
(86) PCT No.: PCT/US2023/081605

§ 371 Date: Apr. 21, 2025

Related U.S. Application Data
(60) Provisional application No. 63/385,560, filed on Nov. 30, 2022.

(51) Int. Cl. C09D 5/16; C09D 7/62; C09D 7/65; C09D 7/80; C09D 183/10

(52) U.S. Cl. CPC C09D 5/1675; C09D 5/1618; C09D 5/1637; C09D 7/62; C09D 7/65; C09D 7/80; C09D 183/10

(57) ABSTRACT

Radiative cooling paint mixtures, single-layer radiative cooling paints formed therefrom, and methods of producing and using such mixtures and paints. The radiative cooling paint mixtures contain a water-based silicone-derived binder, water in which the water-based silicone-derived binder is diluted, a hydrophobing agent, and a radiative cooling pigment, and single-layer radiative cooling paints formed therefrom. The radiative cooling paints emit more thermal energy than solar energy they absorb, thereby achieving a passive radiative cooling effect, while simultaneously achieving hydrophobic and weather-resistance properties and enhanced mechanical integrity.

### CROSS-REFERENCE TO RELATED APPLICATIONS

This application claims the benefit of provisional U.S. Patent Application No. 63/385,560 filed Nov. 30, 2022, the contents of which are incorporated herein by reference.

### STATEMENT REGARDING FEDERALLY SPONSORED RESEARCH OR DEVELOPMENT

This invention was made with government support under Contract No. 2102645 awarded by the U.S. National Science Foundation. The government has certain rights in the invention.

### BACKGROUND OF THE INVENTION

The present invention generally relates to radiative cooling paints capable of dissipating thermal energy from surfaces to which they are applied. The invention particularly relates to water-based radiative cooling paints that are highly water-resistant, self-cleaning, mechanically robust, and provide passive radiative cooling.

Cooling and air conditioning have become increasingly crucial for modern life. Conventional air conditioning methods rely on active cooling techniques, which effectively cool the interior of a building but consume energy, emit thermal energy into the earth and atmosphere, and often require coolants that may promote global warming. Therefore, passive cooling techniques that do not rely on the aforementioned techniques and are environmentally friendly, economical, and scalable are desirable to reduce energy costs and combat global warming. Radiative cooling is one such passive cooling technique.

Radiative cooling functions by minimizing a surface's absorption of incoming solar energy from wavelengths of about 250 nanometers (nm) to about 0.5 micrometer (μm) and maximizing emittance of thermal energy from wavelengths of about 8 to about 13 μm, a spectrum known as the “sky window” in which thermal radiation passes through the atmosphere and is emitted directly into deep space, which serves as an infinite heat sink. Radiative cooling is achieved if the emitted thermal radiation exceeds the absorbed solar radiation.

Early work in radiative cooling featured multilayer structures having an upper layer of highly emissive paint and a base layer of highly reflective metal. For example, early solutions to radiative cooling included painting an aluminum plate with white paint. However, the cooling effect was due to the high reflectivity of the metal plate, rather than the paint alone. Furthermore, this dual-layer technology is not ideal for large-scale implementation due to the difficulty and cost of applying metal layers to non-metal materials. In particular, applying metal to residential buildings presents problems with scalability, application, and economic infeasibility that render it an undesirable solution for wide-scale implementation.

Additional radiative cooling concepts have been proposed, for example, photonic crystals, polymer-metal dual layer, silica-metal dual layer, radiative cooling paper, and cooling wood have been suggested for radiative cooling applications. Most of the aforementioned concepts are either expensive to fabricate or difficult to scale. Recent developments have gone beyond dual-layer systems. For example, air pockets have been added to material matrices to enhance reflectance and achieve sub-ambient temperatures. Current research efforts have explored various pigments for use with single-layer sub-ambient cooling, including hexagonal boron nitride (hBN). Within these works, optimization efforts focused on particle size distribution have further refined the positive effects of radiative cooling paints.

Recent solutions have explored the use of a nano-particle matrix paint for radiative cooling applications which achieved full daytime radiative cooling with a single layer. The paint utilizes a binder matrix containing radiative cooling pigments with a selective particle size comparable to the wavelength of incoming solar energy to achieve efficient broadband scattering of sunlight. Ultraviolet (UV) radiation absorption is eliminated through the use of a wide electronic band gap material, and a high pigment volume in the paint mixture is utilized to overcome the moderate refractive index of the wide band gap material. The paint incorporates calcium carbonate (CaCO₃), which has a high electronic band gap, and has exhibited a high solar reflectance of 95.5% and high thermal emittance of 0.94 into the sky window.

Another recent solution has explored the use of an ultra-white radiative cooling paint, and has achieved a solar reflectance of 98.1% and thermal emittance of 0.96, the highest values yet recorded at time of writing. This was achieved using barium sulphate (BaSO₄), which also has a high electronic band gap, adopting a broad particle size distribution, an appropriate particle size, and high pigment-volume concentration.

Although BaSO₄ and CaCO₃ provide high performance in advantageous properties, scalability, and cost-effectiveness with regard to applications in radiative cooling paints, their compositions may exhibit undesirable characteristics. Specifically, the paints' formulations utilize dimethylformamide (DMF) as a solvent to dissolve a binder. DMF is a volatile organic compound (VOC), which compromises the paints' abilities to withstand UV radiation, contamination, and long-term environmental exposure and maintain mechanical integrity. Mitigating the effects of VOCs is necessary to ensure reliability, scalability, and commercial applicability of radiative cooling paints.

In view of the above, it can be appreciated that it would be desirable if single-layer radiative cooling paints were available that provided greater UV resistance, water repellency, and mechanical integrity to promote their application and widespread use, while also minimizing VOCs.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, compositions for radiative cooling paint mixtures and single-layer paints produced therefrom, as well as methods for their production and use.

According to one nonlimiting aspect of the invention, a radiative cooling paint mixture is provided that contains a water-based silicone-derived binder, water in which the water-based silicone-derived binder is diluted, a hydrophobing agent, and a radiative cooling pigment.

According to another nonlimiting aspect of the invention, a method is provided for producing the radiative cooling paint mixture. The method includes diluting the water-based silicone-derived binder in the water at a predetermined ratio to produce a water-diluted binder, adding the hydrophobing agent to the water-diluted binder at a predetermined mass-based ratio, mixing the water-diluted binder and hydrophobing agent to form a homogenous solution, adding particles of the radiative cooling pigment to the homogenous solution at a predetermined volume-based concentration to form the radiative cooling paint mixture, and ultrasonicating the radiative cooling paint mixture until the particles of the radiative cooling pigment are no longer suspended.

According to yet another nonlimiting aspect of the invention, a method of using the radiative cooling paint mixture includes applying the radiative cooling paint mixture to a surface or structure, such that passive radiative cooling is achieved on the surface or in spaces enclosed by the structure.

Still another nonlimiting aspect of the invention is a single-layer paint formed with the radiative cooling paint mixture.

Technical aspects of radiative cooling paint mixtures, resulting single-layer paints, and methods as described above preferably include the ability to provide radiative cooling paint mixtures in which the use of VOCs is minimized, while also providing water repellency, mechanical integrity, and resistance to UV absorption.

Other aspects and advantages will be appreciated from the following detailed description as well as any drawings.

### BRIEF DESCRIPTION OF THE DRAWINGS

FIGS. 1A through IC contain graphs summarizing optical performances measured for a BaSO₄ radiative cooling paint (FIG. 1A), a CaCO₃ radiative cooling paint (FIG. 1B), and a TiO₂-containing paint commercially available under the name Henry 887 Tropi-cool 100% silicone white roof coating (FIG. 1C). Both water-based radiative cooling paints surpassed the commercial product in optical performance as a result of having a wide band gap that prevented the absorption of UV, unlike the commercial product that contains TiO₂ as a pigment in its composition.

FIGS. 2A through 2C contain images demonstrating the hydrophobic performance of the above-noted radiative cooling paints by evaluating the contact angle of the water beading effects for the paints. The BaSO₄ radiative cooling paint (FIG. 2A) exhibits contact angles of about 92 degrees to about 93.4 degrees, and the CaCO₃ radiative cooling paint (FIG. 2B) exhibits contact angles of about 124 degrees to about 140 degrees. In contrast, the TiO₂-based commercial product (FIG. 2C) exhibits a contact angle of about 90.24 degrees.

FIG. 3 contains SEM images showing the above-noted BaSO₄ and CaCO₃ radiative cooling paints, in which highly porous and dense structures can be observed. The dense structures provide added strength, and pores contribute to hydrophobic characteristics of the paints. The pores of the paints can be seen as quite small but abundant, which also contributes to optical performance.

FIG. 4 is a schematic representation of a process of fabricating a water-based paint according to some nonlimiting aspects of the invention.

FIGS. 5A through 5C present particle distributions for three water-based paint compositions made with BaSO₄ particles (FIG. 5A), CaCO₃ particles (FIG. 5B), and hBN particles (FIG. 5C) prepared in accordance with the process of FIG. 4.

FIG. 6 is a graph that compares the three water-based paint compositions and two commercially available paints and evidences the ability of the water-based paint compositions to absorb UV and near-infrared wavelengths as indicated by low reflectance.

FIGS. 7A, 7B, and 7C show images from sessile droplet tests of water-based paints, demonstrating hydrophobic capabilities of BaSO₄, CaCO₃, and hBN compositions characterized by contact angles.

FIG. 8 shows test results of an outdoor experiment of the cooling performance of the water-based paints across sixty hours, which shows the below ambient performance of the water-based paints.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of the embodiment(s). The following detailed description also describes certain investigations relating to the embodiment(s), and identifies certain but not all alternatives of the embodiment(s). As nonlimiting examples, the invention encompasses additional or alternative embodiments in which one or more features or aspects described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

The terms “a” and “an” as used herein to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

According to one nonlimiting aspect of the invention, water-based radiative cooling paints (sometimes more simply referred to as water-based paints, radiative cooling paints, or paints) are provided that reduce VOCs while also achieving high solar reflectance and high thermal emittance in order to accomplish passive radiative cooling. The paints also exhibit waterproofing and hydrophobic characteristics, weathering resistance, UV resistance, and enhanced mechanical integrity. The radiative cooling paints are produced from paint mixtures that contains a radiative cooling pigment, a water-based silicone-derived binder, and a hydrophobing agent. The water-based silicone-derived binder can be diluted with water and in so doing eliminates the need for a chemical solvent, such as a VOC. The water-based silicone-derived binder also exhibits hydrophobic properties and may be present in the radiative cooling paint to achieve sub-ambient radiative cooling and retain high transmission and low absorption in the required spectrum even after long-term exposure to contaminants and natural elements.

In investigations leading to the present invention, water-based radiative cooling paints were developed using calcium carbonate (CaCO₃), barium sulfate (BaSO₄), or hexagonal boron nitride (hBN) particles to achieve high solar reflectance of 95.4%, 93.7%, and 96.1%, respectively, high thermal emittance of 93.6%, 94%, and 85.7%, respectively, and overcome weathering challenges while also significantly reducing VOC content. In one of the investigations, three paints made with these three different particles achieved hydrophobic characteristics achieving high contact angles of 118°, 139.9°, and 136.7° for the BaSO₄, CaCO₃, and hBN-based compositions, respectively. The performances of the hydrophobic water-based radiative cooling paints surpassed current industry products, and/or was comparable to published radiative cooling solutions in the literature.

In accordance with some aspects of the invention, hydrophobic water-based radiative cooling paints characterized by nanoparticle-matrices have successfully achieved full daytime radiative cooling through a singular layer of paint. These compositions employ particles with dimensions closely aligned with the solar wavelength, thereby facilitating efficient broadband scattering of sunlight, and the inclusion of wide electronic band gap materials that effectively mitigate UV absorption. To compensate for the moderate refractive index intrinsic to wide band gap materials, a high pigment volume concentration (PVC) is employed. Although paint compositions can vary, a so-called critical PVC content (cPVC) is believed to lie in a range of from about 30% to about 60%. The cPVC was ascertained during the investigations using ASTM D281 tests. The PVC selected preferably exceeds the cPVC for each pigment particle type to improve scattering. Exceeding this value may lead to a steep increase in the coating's porosity, which synergistically enhances light scattering, particularly when used in conjunction with high band gap pigment materials. In some embodiments, paint compositions incorporating CaCO₃, BaSO₄, and hBN pigment particles produced paints that demonstrated excellent solar reflectances of 95.5%, 98.1%, and 97.9%, respectively, along with high thermal emittances of 0.94, 0.95, and 0.84, respectively, in the atmospheric sky window.

Paint compositions within the scope of the invention preferably incorporate a paint binder in the form of an aqueous dispersion of polymer particles and pigment particles, as opposed to utilizing a solid resin, which avoids the necessity for chemical solvents containing VOCs and allowing for dilution with water. In such an aqueous dispersion, oil droplets are dispersed in a continuous water phase, facilitated by surface-active agents known as emulsifiers or surfactants, which confer system stability by adsorbing to both polymer and water phases, resulting in a stable emulsion. Upon water evaporation, the polymer particles undergo diffusion and coalescence, spontaneously self-assembling into a polymer matrix that forms a cohesive solid film. Following the evaporation of the water, the pigment particles remain uniformly dispersed within the polymer matrix, thereby forming a coating layer. Preferably, a silicone-based binder in a water dispersion form may be used to achieve a highly stable and durable paint film.

A particular but nonlimiting example of a water-based silicone-derived binder that was evaluated during the investigations is a silicone modified polyurethane dispersion, such as commercially available from Evonik Operations GmbH under the name SILIKOPUR® 8081, and a particular but nonlimiting example of a hydrophobing agent that was evaluated during the investigations is a functional polysiloxane formulation, such as commercially available from Evonik Operations GmbH under the name TEGO® Phobe 1500 N, both of which are known to those skilled in the art.

In the investigations, the radiative cooling pigments evaluated were BaSO₄, CaCO₃, and/or hBN particles, particularly BaSO₄ and CaCO₃ nanoparticles and hBN nanoplatelets. These pigments can be obtained commercially (typically as pigment particles) and are known to those skilled in the art. The pigment particles are preferably included in the paint mixture at a pigment loading concentration by volume according to the following formula, where L is the pigment loading concentration expressed as a percentage, m is the mass of a material, and p is the density of a material:

$${m}_{pigment} = ( \frac{{m}_{binder}}{{ρ}_{binder}} ) \times ( \frac{{L}_{pigment}}{100 \% - {L}_{pigment}} ) \times {ρ}_{pigment}$$

In the investigations, the pigment loading concentration (L_{pigment}) was about 60% by volume, though greater and less concentrations are foreseeable. The water-based silicone-derived binder was diluted with water, as nonlimiting examples, at a ratio of 1 part binder to about 25 parts water when utilizing BaSO₄ as a pigment, and 1 part binder to about 40 parts water when utilizing CaCO₃ as a pigment. The hydrophobing agent was added to the mixture, as a nonlimiting example, in an amount from about 1% to about 35% by mass of the total mass of the water, binder, and pigment mixture, according to the following formula:

$${m}_{TEGO Phobe 1500 N} = ( {m}_{H 2 O +} {m}_{binder} + {m}_{pigment} ) \times ( \% )$$

A method of producing a water-based radiative cooling paint generally entails diluting the water-based silicone-derived binder in water, adding the hydrophobing agent into the water-diluted binder, thoroughly mixing the hydrophobing agent and binder into a homogenous solution, adding radiative cooling pigment particles into the solution, and ultrasonicating the mixture until the particles are no longer suspended. The resulting water-based radiative cooling paint mixture can be applied to a surface or structure to form the radiative cooling paint, which is preferably operable such that the thermal energy emitted from the paint exceeds the solar energy absorbed by the paint, thereby achieving an advantageous passive radiative cooling effect on the surface or spaces enclosed by the structure while simultaneously achieving hydrophobic and weather-resistant properties and mechanical integrity.

In the investigations leading to the present invention, paint mixtures as described above were applied to glass substrates to ensure that their reflection characteristics were independent of the glass substrates during spectroscopy measurements. The optical properties were evaluated via Perkin Elmer Lambda 950 UV-VIS-NIR spectrometer with an integrating sphere using a certified Spectralon diffuse reflection standard, and the total solar reflection was calculated based on AM 1.5 solar spectrum.

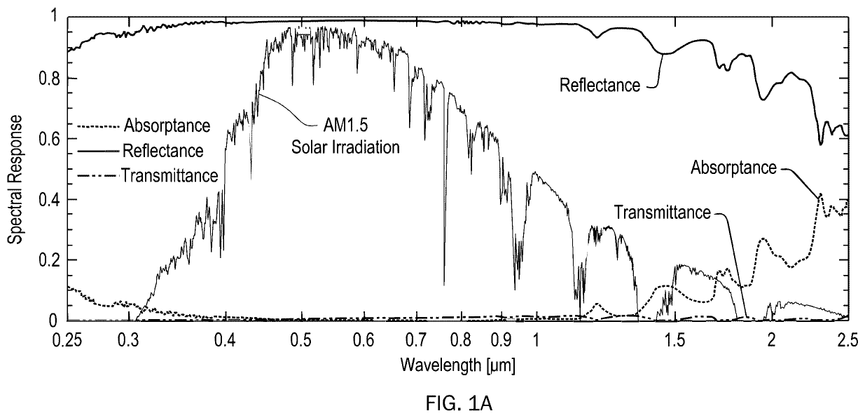

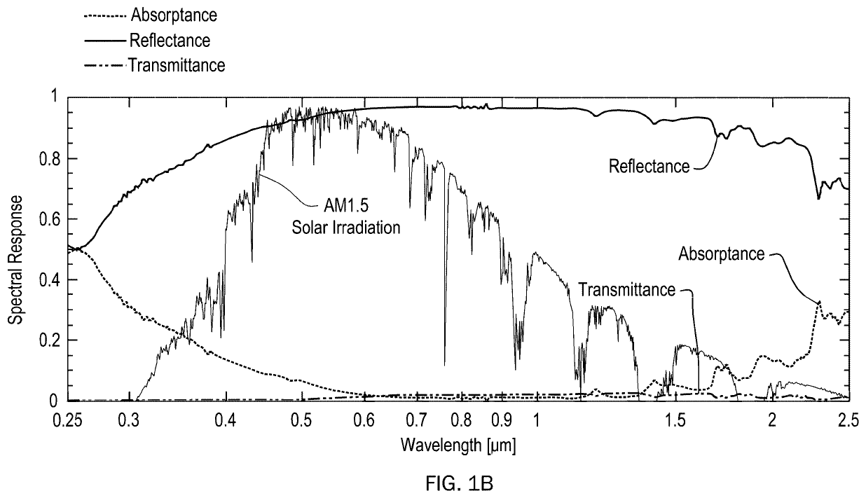

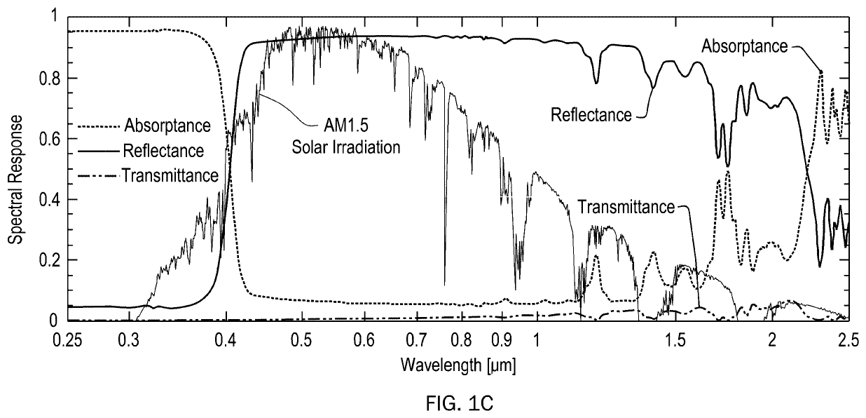

The water-based radiative cooling paints exhibited a high solar reflectance of about 94.5% and thermal emission of about 0.89 in the sky window for the CaCO₃-containing paint, and a high solar reflectance of about 96.5% and thermal emission of about 0.9 in the sky window for the BaSO₄-containing paint. The optical performances were achieved based on sample thicknesses of about 387 μm and about 441 μm for the CaCO₃- and BaSO₄-containing paints, respectively. The commercial sample (Henry 887 Tropi-Cool) exhibited an 86.5% solar reflectance with a paint thickness of around 1.35 mm. FIGS. 1A-1B show the optical responses of the water-based CaCO₃- and BaSO₄-containing paints relative to the commercial sample, which as shown in FIG. 1C exhibited a significant UV absorption attributed to TiO₂ pigment. The total solar reflectance was evaluated based on the AM 1.5 solar spectrum, and the results showed that both water-based radiative cooling paints outperformed the commercial sample.

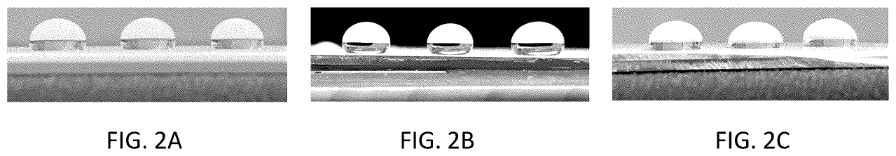

Furthermore, the hydrophobic surface properties of the water-based radiative cooling paints were observed via water contact angle tests, where the CaCO₃-containing paint achieved contact angles of about 125 degrees to about 142 degrees, BaSO₄-containing paint achieved contact angles of about 92 degrees to about 93.4 degrees, and the commercial sample achieved a contact angle of about 90.24 degrees, as shown in FIGS. 2A through 2C.

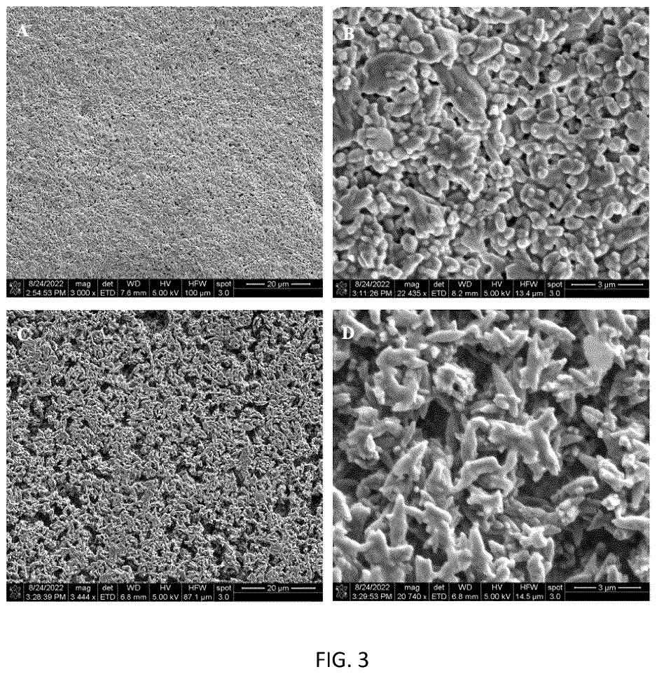

Scanning Electron Microscopy (SEM) images of the water-based BaSO₄ and CaCO₃ radiative cooling paints are shown in images labeled A and B and images labeled C and D, respectively, in FIG. 3. The images demonstrate the internal structure of the water-based radiative cooling paints, which had compact dense structures. Moreover, the structures of both BaSO₄ and CaCO₃ radiative cooling paints maintained small size pores, which inhibit or prevent water from penetrating into the paint internal structure while allowing water vapor to be released into the environment.

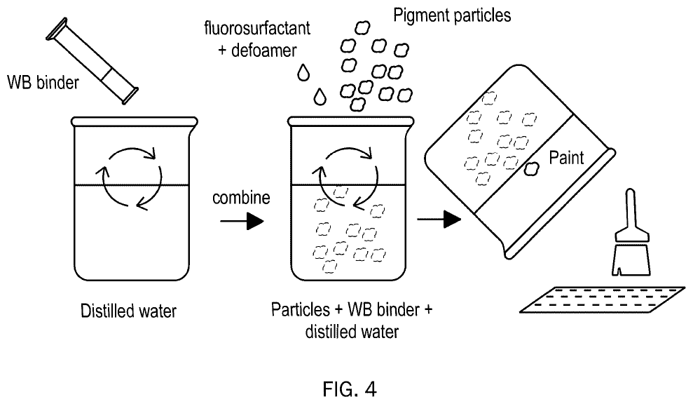

In further investigations leading to the invention, water-based paints were fabricated generally by the process schematically illustrated in FIG. 4. In the investigations, the water-based binder was mixed in distilled water at low shear settings for thirty minutes, followed by pigment addition, which was then stirred for an additional hour. A small amount of anionic fluorosurfactant (to reduce interfacial surface tension) and a defoamer containing fumed silica were used to adjust the viscosity of the water-based paint solution and ensure a stable colloidal paint. Both defoamer and fluorosurfactant were solvent/VOC free and supplied at approximately 0.1% by weight. The paints were then ready to use and were applied to glass slides and aluminum substrates through pouring or brushing techniques. After application, the paints were allowed to dry naturally at ambient conditions.

In one nonlimiting investigation, the SILIKOPUR 8081 was mixed with distilled water and the viscosity of the mixture was adjusted according to the pigment density. In this nonlimiting example, about 1 part binder: 1 part water was used for mixtures containing BaSO₄ particles, while about 1 part binder: 1.5 water was used to form mixtures containing the hBN or CaCO₃ particles. The binder and water were mixed at a low shear rate for approximately thirty minutes to ensure a homogenous mixture. The pigment particles were then added and stirred for an additional one hour. The pigment loading was determined by the relation:

$${m}_{pigment} = \frac{{m}_{binder} \times \% solid}{{ρ}_{binder}} \times \frac{\% concentration}{( 1 - \% concentration )} \times {ρ}_{pigment}$$

The water-based binder was a suspended solid in a volatile solution (containing water and a coalescence agent). The concentration of pigment particles was based on the percent of solid (non-volatile part) which was approximately 33% in the investigations. The rest of the binder solution (67%) consisted essentially of volatile agents (approximately 62% water and 5% coalescence agent). Percent concentration (PVC) was determined to be 60%, while the (1−% concentration) part represents the binder volume concentration of the solid part of water-based binder. A small amount of fumed silica-containing defoamer, such as a solvent free-mixture of colloidal silica particles (e.g., Airex902) was used to prevent foaming. A VOC-free anionic fluorosurfactant was added at a small amount to ensure stability and good dispersion of the naturally hydrophobic pigment particles (especially for hBN and CaCO₃) and help to lower the surface tension of the water, which provided better wetting and leveling when applied on surfaces. Both anionic flourosurfactants (Thetawet FS-8225) and defoamer (TEGO® Airex 902 W N) were added in 0.1% by weight following the relation:

$${m}_{defoamer / surfactant} = ( {m}_{binder} + {m}_{water} + {m}_{pigment} ) \times 0.001$$

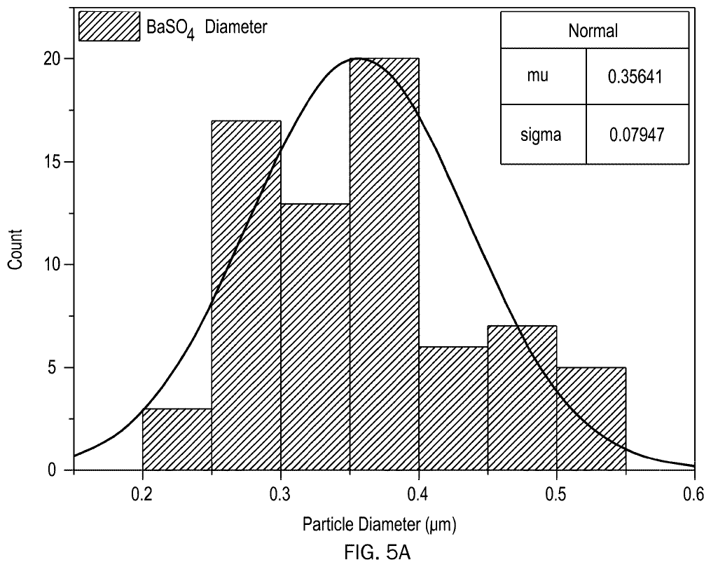

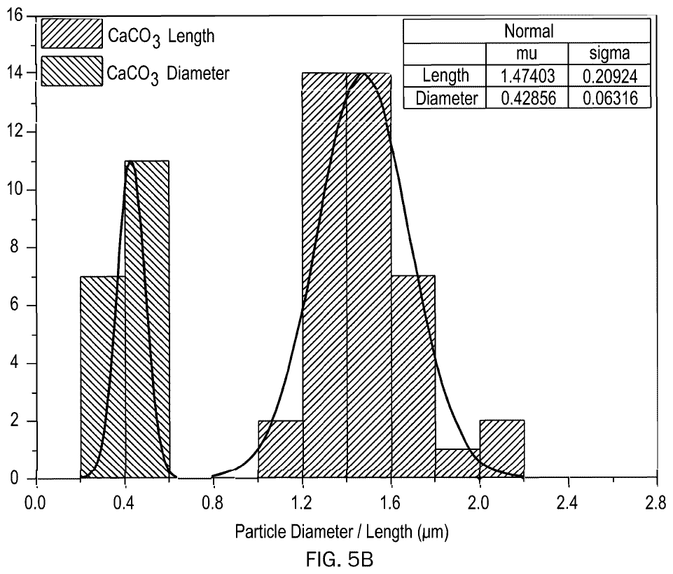

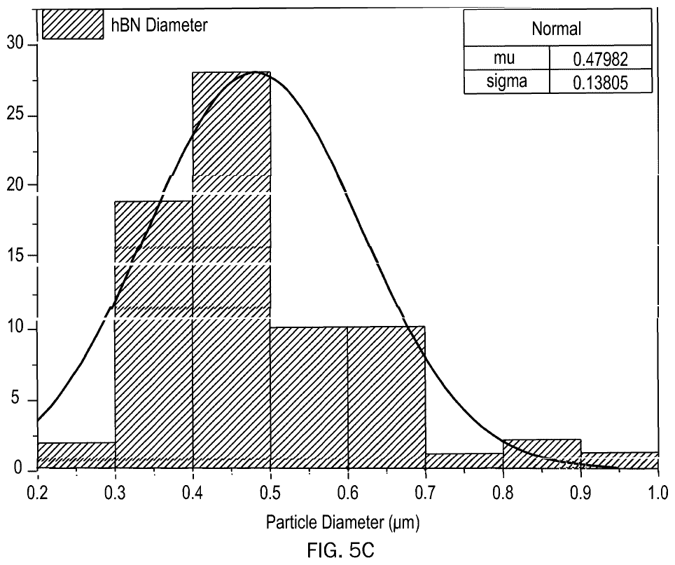

Testing showed that, in paints prepared in accordance with this process, the presence of pores in the coatings confirmed the PVC>cPVC relation discussed above, where the calculated cPVC of BaSO₄ was about 51%. The average porosity of the dried film of BaSO₄ paint was calculated to be about 32% with a standard deviation of 2.4%. Moreover, BaSO₄ particle size distributions were an average size of about 356 nm. Similar features were found with the CaCO₃-containing paint; however, its CaCO₃ particles are fully encapsulated by the oil phase, which may be attributed to the high measured CaCO₃ OA value of 80 (g oil/100 CaCO₃). The fusion between oil and pigment phases yielded a better water resistance performance, and lower hydrogen bonding between water molecules and CaCO₃ particles are covered by the binder phase. Moreover, the CaCO₃ morphology had a needle like shape with high aspect ratios (heights (h) of about 1.47 μm and diameters (d) of about 426 μm), which may further improve paint surface roughness. Also, the CaCO₃ composition contained a porous structure due to PVC>cPVC, where cPVC for CaCO₃ was calculated to be about 30%. Average porosity of the CaCO₃-containing paint was calculated to be about 54.3% with a standard deviation of 4.2%. The hBN-containing paint exhibited the thin platelets morphology of hBN. The platelets exhibited high features with an average diameter (d) of about 479 nm. The platelets were randomly oriented, which could be a consequence of shear force exerted during paint application. Given that hBN has an oil absorption (OA) value of about 96 (g oil/100 hBN), it had a calculated cPVC of about 31%, which yields a similar porous structure with an average porosity value of about 62.1% with a standard deviation of 3.4%. The volume concentrations of pigments and water-based binder in the wet paint mixture were 60% and 40%, respectively, within the solid phases. Once the paint dried, resulting in 32%, 54.3%, and 62.1% porosities, the pigment distribution was adjusted to be about 40.1% for the BaSO₄ composition, about 27.4% for the CaCO₃ composition, and about 22.7% for the hBN composition. Similarly, the water-based binder content was adjusted to be about 27.2%, about 18.3%, and about 15.2%, for the BaSO₄, CaCO₃, and hBN compositions, respectively. FIGS. 5A-5C present the size distributions of the BaSO₄, and hBN particle diameters, as well as the average length and diameter of the CaCO₃ particles. The distributions highlight a wider range of pigment sizes with CaCO₃ exhibiting less uniformity. In contrast, the BaSO₄ and hBN particles were more uniformly sized, aligning closely with the solar spectrum's peak wavelength, which leads to improved light scattering. The VOC content for the water-based paints was determined to be 21.3, 3.9, and 3.7 g/L for the BaSO₄, CaCO₃, and hBN compositions, respectively. Meanwhile, commercial water-based paints have reported VOC contents of less than 200 and 50 g/L for CoolWall and Resilience acrylic latex paints, respectively. The water-based paints satisfy the low VOC criteria for the BaSO₄ composition, with the CaCO₃ and hBN compositions achieving zero VOC status (based on the South Coast Air Quality Management District Rule 113), all without sacrificing cooling performance.

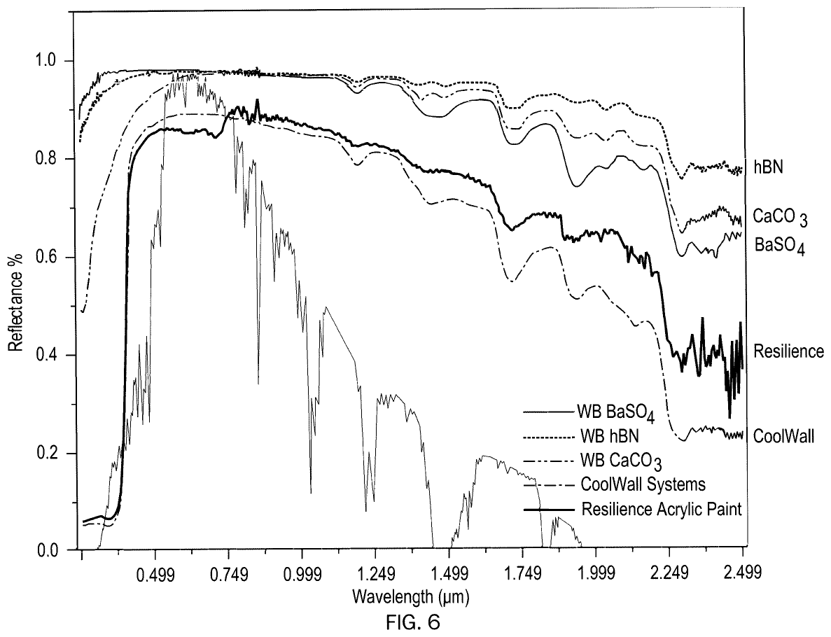

The spectral reflectances of the three water-based paints versus two commercially-available paint systems (Tex-Cote® CoolWall® coating system and Resilience® acrylic latex paint) are presented in FIG. 6, which shows that all three water-based (WB) paints surpassed the commercial products in terms of reflectance in both the near infrared and UV regions (seen in FIG. 6 as, respectively, below 0.400 μm and above 0.750 μm).

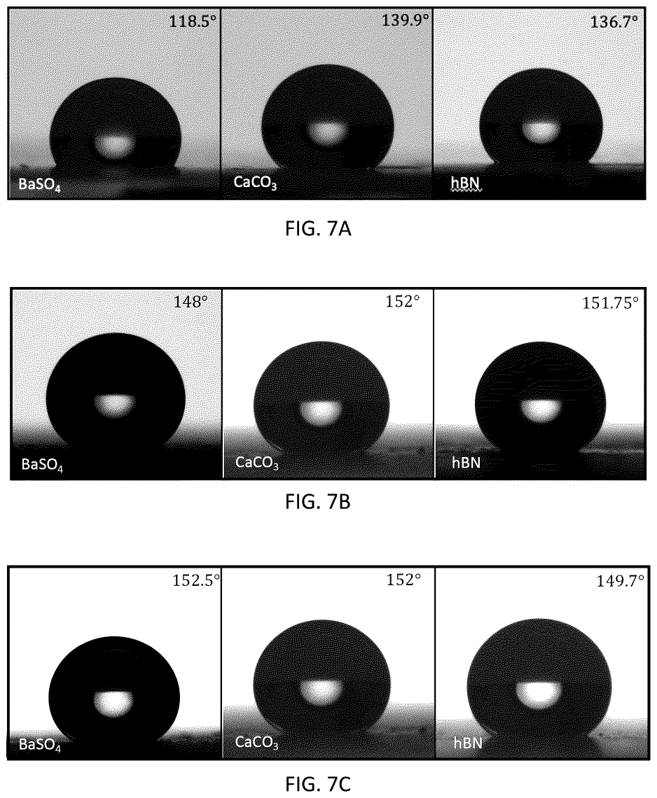

Hydrophobicity was evaluated based on sessile droplet contact angle, to indicate wettability characteristics of the water-based paints. FIG. 7A shows the contact angle (CA) of the water-based paint compositions, in which the BaSO₄, CaCO₃, and hBN-based water-based paints exhibited high contact angles of 118.5°, 139.9°, and 136.4° respectively. While the paints were made from the same silicone-based binder and hydrophobing agent (the functional polysiloxane formulation known as TEGO Phobe 1500 N), there were differences in performance, which may be attributed to several factors. Firstly, the morphology of the pigments differed, from spherical, cylindrical (needle shape), to platelet shapes, where a higher aspect ratio may result in a higher water contact angle. This trend can be seen in a higher hydrophobic performance of the CaCO₃ (needle shape) and hBN (platelet shape) compositions, in contrast with the BaSO₄ (spherical shape) composition. Higher features and aspect ratio may enhance overall surface roughness, in contrast with closed packed smooth spherical packing. Moreover, oil absorption could have some influence on the hydrophobic performance, due to BaSO₄ having a lower oil absorption value, which may indicate higher affinity to water in contrast to hBN and CaCO₃.

During additional testing performed during the investigations, high hydrophobic performance, denoted by achieving very high water contact angles (greater than 145 degrees), was shown as being achieved with the use of hydrophobic fumed silica (such as commercially available from Evonik Operations GmbH under the name AEROSIL® E 972) and/or three-dimensional hydrophobic silicone polymers known as polysilsesquioxanes (such as commercially available from Coating Products OHZ E.K. under the name Polypearl™ ME Series) as the hydrophobing agent. Hydrophobicity of paint formulations was evaluated based on sessile droplet contact angle to indicate wettability characteristics of the water-based paints as described above but with AEROSIL® E 972 or Polypearl™ ME as the hydrophobing agent. FIG. 7B shows the BaSO₄, CaCO₃, and hBN-based water-based paints containing Polypearl™ ME as the hydrophobing agent exhibited contact angles of 148°, 152°, and 151.75°, respectively, and FIG. 7C shows the BaSO₄, CaCO₃, and hBN-based water-based paints containing AEROSIL® E 972 as the hydrophobing agent exhibited contact angles of 152.5°, 152°, and 149.7°, respectively. As such, the use of one or more hydrophobing agents other than or in addition to a functional polysiloxane formulation is also within the scope of the invention.

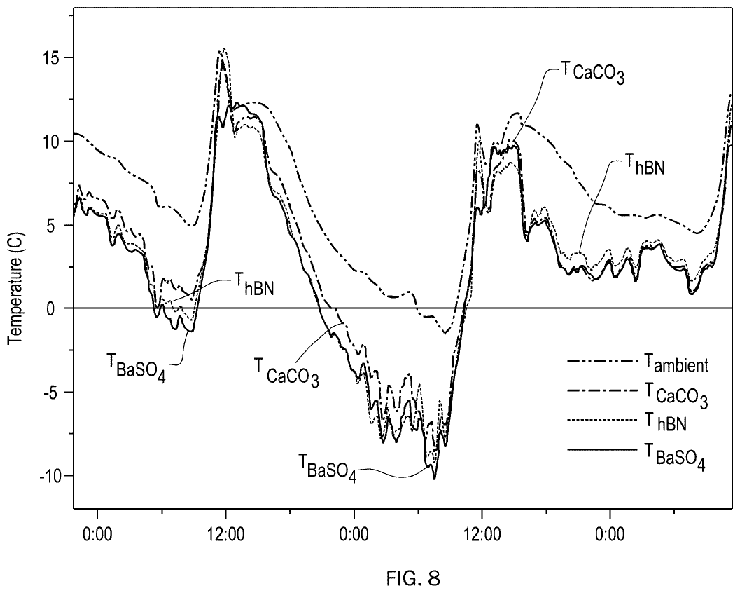

Outdoor experiments of the three water-based paints were performed that captured the thermal behavior of the water-based paints alongside local ambient temperature (T_{ambient}). Each paint variant was applied to 6×6 inch (15×15 cm) aluminum plates, with thicknesses of about 533 μm, about 512 μm, and about 900 μm for the BaSO₄, hBN, and CaCO₃ compositions, respectively. As seen in FIG. 8, the water-based paints provided outdoor cooling efficacy, indicating below ambient temperatures during both day and night. Across sixty hours of observation plotted in FIG. 8, the water-based paints maintained an average temperature of approximately 4.4° C., 4.1° C., and 3.7° C. below the ambient temperature for the BaSO₄, hBN, and CaCO₃ compositions, respectively. (It is noted, however, that the test data exhibited pronounced variability, suggesting potential experimental inaccuracies, leading to unexpectedly high temperature deviations at some data points.) Moreover, sky window emittance values of 0.936 for BaSO₄, 0.857 for hBN, and 0.94 for CaCO₃ contributed to significant temperature disparities of roughly 9° C., 8.2° C., and 6.2° C. below ambient, respectively.

To thoroughly assess the robustness and longevity of the water-based paints, a series of standardized tests were conducted. The water-based paints displayed ASTM D570 W₂₄ values under 0.1 kg/(m²√h), signifying minimal water uptake and excellent resistance to moisture. Notably, the hBN and CaCO₃-containing paints exhibited even lower values than the BaSO₄ composition, underscoring their enhanced hydrophobic capabilities. However, all paint compositions maintained low absorption rates, an important factor in preventing water-induced degradation. The paint specimens also underwent rigorous environmental chamber trials, where they were subjected to intense UV light, elevated temperatures, and high humidity to mimic extreme weather conditions. Evaluations of paint reflectance before and after these accelerated weathering tests revealed negligible changes in functional performance or aesthetic qualities. The durability of the water-based paints under abrasion was confirmed by being subjected to 2500 cycles of wear without notable mass loss, further attesting to the binders' mechanical fortitude.

From the investigations, it was concluded that water-based radiative cooling paints enable the mitigation of high levels of VOCs, enhance mechanical strength, and demonstrate hydrophobic surface properties which activate self-cleaning and promote UV and weathering resistance. The high cooling performances were achieved utilizing high pigment loading, intrinsic wide band gap materials, appropriate particle size, and broad size distribution approaches. Reduced VOC content was obtained by employing a paint binder in an emulsion form, allowing for water dilution, and eliminating the use of chemical solvents. Moreover, the presence of silicone and polyurethane in the binder provides strength, UV resistance, breathability, and moisture resistance and improves paint protection from cracking, blistering, and decomposing. Furthermore, the hydrophobing agent of a functional polysiloxane group enhanced water proofing, and demonstrated a self-cleaning behavior, resulting in high (greater than 90 degrees) water contact angles. The investigations demonstrated the combined benefits of high cooling performance, physical robustness, self-cleaning feature, and convenience of paint application.

In some nonlimiting embodiments, the water-based paint may utilize a silicone polyurethane modified dispersion, by which a polymer is directly dispersed within a continuous aqueous phase. The oil phase is stabilized utilizing surface active agents (surfactants), which acts as a bridge reducing the interfacial surface tension between the polar water phase and non-polar oil phase. High solar reflectance was achieved via employing high band gab materials, added at a high pigment volume concentration (PVC) to mitigate the solar absorption in the UV band, despite its moderate refractive index. To ensure a high optical performance, a high PVC is preferred at a level higher than the critical PVC (cPVC). At a PVC>cPVC, air pores are introduced to the coating composites acting as scattering bodies, that further enhance reflection. The water-based paint may have a volume concentration of about 60% pigment and about 40% binder, based on BaSO₄, hBN, and CaCO₃ pigment particles. Such water-based paints have achieved a total solar reflectance of about 95.4%, about 96.1%, and about 93.7% for the BaSO₄, hBN, and CaCO₃-containing paints, respectively, and porosity contents of approximately 32%, 62.1%, and 54.3% for the BaSO₄, hBN, and CaCO₃-containing paints, respectively. Moreover, the BaSO₄, hBN, and CaCO₃-containing paints have achieved high thermal emission through the sky window, respectively, about 0.936, 0.857, 0.94. Thus, a possible below ambient performance is feasible with a net positive figure of merit, which records 0.629, 0.49, 0.578 for BaSO₄, hBN, and CaCO₃-containing paints, respectively. Furthermore, the BaSO₄, hBN, and CaCO₃-containing paints produced water contact angles of 118.5, 136.7, and 139.9 degrees, respectively, demonstrating good hydrophobic performance. Additionally, the water-based paints achieved high cooling performances characterized by an average daylight temperature difference of 4.4° C., 4.1° C., and 3.7° C. below the ambient temperature for the BaSO₄, hBN, and CaCO₃-containing paints, respectively.

As previously noted above, though the foregoing brief description describes certain aspects of one or more particular embodiments of the invention, alternatives could be adopted by one skilled in the art. As such, and again as was previously noted, it should be understood that the invention is not necessarily limited to any particular embodiment described herein.

1. A radiative cooling paint mixture comprising:
a water-based silicone-derived binder;
water in which the water-based silicone-derived binder is diluted;
a hydrophobing agent; and
a radiative cooling pigment.

2. The radiative cooling paint mixture of claim 1, wherein the water-based silicone-derived binder comprises a silicone modified polyurethane dispersion.

3. The radiative cooling paint mixture of claim 1, wherein the hydrophobing agent comprises one or more of a functional polysiloxane, hydrophobic fumed silica, and polysilsesquioxane.

4. The radiative cooling paint mixture of claim 1, wherein the radiative cooling pigment comprises CaCO₃.

5. The radiative cooling paint mixture of claim 4, wherein the water-based silicone-derived binder is diluted with the water at a ratio of 1 part binder to about 40 parts water.

6. The radiative cooling paint mixture of claim 4, wherein the water-based silicone-derived binder is diluted with the water at a ratio of 1 part binder to about 1.5 parts water.

7. The radiative cooling paint mixture of claim 1, wherein the radiative cooling pigment comprises BaSO₄.

8. The radiative cooling paint mixture of claim 7, wherein the water-based silicone-derived binder is diluted with the water at a ratio of 1 part binder to about 25 parts water.

9. The radiative cooling paint mixture of claim 7, wherein the water-based silicone-derived binder is diluted with the water at a ratio of 1 part binder to about 1 part water.

10. The radiative cooling paint mixture of claim 1, wherein radiative cooling pigment comprises hexagonal boron nitride (hBN).

11. The radiative cooling paint mixture of claim 10, wherein the water-based silicone-derived binder is diluted with the water at a ratio of 1 part binder to about 1.5 parts water.

12. The radiative cooling paint mixture of claim 1, wherein the hydrophobing agent is present in an amount of about 1% to about 35% by mass of the combined mass of the water, the water-based silicone-derived binder, and the radiative cooling pigment.

13. The radiative cooling paint mixture of claim 1, wherein a pigment loading concentration, by volume, of the radiative cooling pigment to the water-based silicone-derived binder is about 60%.

14. A method of producing the radiative cooling paint mixture of claim 1, the method comprising:
diluting the water-based silicone-derived binder in the water at a predetermined ratio to produce a water-diluted binder;
adding the hydrophobing agent to the water-diluted binder at a predetermined mass-based ratio;
mixing the water-diluted binder and hydrophobing agent to form a homogenous solution;
adding particles of the radiative cooling pigment to the homogenous solution at a predetermined volume-based concentration to form the radiative cooling paint mixture; and
ultrasonicating the radiative cooling paint mixture until substantially all the particles of the radiative cooling pigment are no longer suspended.

15. A method of using the radiative cooling paint mixture of claim 1, the method comprising applying the radiative cooling paint mixture to a surface to form a single-layer paint that achieves passive radiative cooling on the surface or in spaces enclosed by the structure.

16. A single-layer paint formed with the radiative cooling paint mixture of claim 1.
